(19) United States
(12) Patent Application Publication
(10) Pub. No.: US 2026/0034838 A1
(43) Pub. Date: Feb. 5, 2026

(54) TIRE TREAD PATTERN WITH IMPROVED WEAR RESISTANCE

(71) Applicant: The Goodyear Tire & Rubber Company, Akron, OH (US)

(72) Inventors: David Michael Pribula, Akron, OH (US); Jonathan James Shondel, Akron, OH (US); Paul Bryan Maxwell, Akron, OH (US)

(21) Appl. No.: 18/788,598

(22) Filed: Jul. 30, 2024

(51) Int. Cl. B60C 11/04; B60C 11/03; B60C 11/12

(52) U.S. Cl. CPC B60C 11/04; B60C 11/0306; B60C 11/12; B60C 2011/0341; B60C 2011/0358

(57) ABSTRACT

A tire comprising a tread portion divided between a central portion and two shoulder portions; wherein two main external grooves extending in a circumferential direction of the tire are each disposed between the central portion and one of the two shoulder portions; wherein the central portion comprises a first intermediate rib, a second intermediate rib, and a central rib, each of the shoulder portions has a plurality of shoulder blocks in the shoulder portion; wherein at least one shoulder block shows at least one lateral sipe; each of the first intermediate rib and the second intermediate rib has a plurality of intermediate blocks in the intermediate ribs, wherein the intermediate blocks show a central sipe opened on either side of the intermediate block and arranged to have an opening on the main external groove facing an opening on the same main external groove of an adjacent shoulder lateral groove.

### FIELD OF THE INVENTION

The present disclosure relates to a tire, and in particular to a tire that can be used as all-season tire or winter tire.

### BACKGROUND OF THE INVENTION

Pneumatic tires are essential for ensuring safety, performance, and fuel efficiency of vehicles. Among the various factors involved, tread design plays a pivotal role, particularly in wear.

Tire wear significantly affects vehicle safety. The tread pattern on a tire is designed to provide traction and facilitate water evacuation from beneath the tire's footprint. As tires wear, tread depth diminishes, reducing their ability to prevent hydroplaning and compromising traction on wet, or snowy surfaces. There is a constant need for effective tread designs that can enhance wear resistance, thereby maintaining safety standards over a longer period.

The performance of a vehicle is intrinsically linked to the condition of its tires. Tire wear alters the tread pattern, impacting handling, braking, and acceleration. A well-designed tread pattern can help maintain optimal performance characteristics by promoting, even in a worn state, the tire's grip and responsiveness throughout its lifespan.

There is a need to further improve the performance of the all season tires and winter tires in particular regarding the wear resistance. There is also a need for a tire combining at the same tire wear resistance and noise reduction, such as wear resistance and noise reduction and stiffness.

### SUMMARY OF THE INVENTION

One or more of the above needs can be fulfilled by the tire according to the disclosure.

According to a first aspect, the disclosure provides for a tire comprising a tread portion that is divided in a tire width direction between a central portion and two shoulder portions; the shoulder portions being placed on either side of the central portion; wherein two main external grooves extending in a circumferential direction of the tire are each disposed between the central portion and one of the two shoulder portions; wherein the central portion comprises two main central grooves extending in the circumferential direction and defining a first intermediate rib, a second intermediate rib and a central rib, the first intermediate rib and the second intermediate ribs being placed on either side of the central rib; each of the shoulder portions has a plurality of shoulder lateral grooves defining a plurality of shoulder blocks in the shoulder portion wherein at least one shoulder block show at least one lateral sipe; each of the first intermediate rib and the second intermediate rib has a plurality of intermediate lateral grooves defining a plurality of intermediate blocks in the intermediate ribs, the intermediate lateral grooves of the first intermediate rib extend in an inclined axial direction angularly opposite to a direction of the intermediate lateral grooves of the second intermediate rib, wherein the intermediate blocks show a central sipe extending in a same direction as the adjacent intermediate lateral grooves; said central sipe is opened on either side of the intermediate block and arranged to have an opening on the main external groove facing an opening on the same main external groove of an adjacent shoulder lateral groove.

According to a second aspect, the disclosure provide for a tire comprising a tread portion that is divided in a tire width direction between a central portion and at least one shoulder portion; the shoulder portion being placed adjacent to the central portion; wherein a main external groove extending in a circumferential direction of the tire is disposed between the central portion and the shoulder portion; wherein the central portion comprises at least one main central groove extending in a circumferential direction and defining at least one intermediate rib and a central rib, the intermediate rib being placed between the shoulder portion and the central rib; the shoulder portion shows a plurality of shoulder lateral grooves defining a plurality of shoulder blocks wherein at least one shoulder block shows at least one lateral sipe; the intermediate rib shows a plurality of intermediate lateral grooves defining a plurality of intermediate blocks, wherein the intermediate blocks show a central sipe extending in a same direction as the lateral grooves of the intermediate rib, said central sipe is opened on the main external groove and faces the opening on the main external groove of a shoulder lateral groove of the adjacent shoulder portion.

According to a third aspect, the disclosure provide for a tire comprising a tread portion that is divided in a tire width direction between a central portion and two shoulder portions; the shoulder portions being placed on either side of the central portion; wherein two main external grooves extending in a circumferential direction of the tire are disposed between the central portion and two shoulder portions; wherein the central portion comprises two main central grooves extending in the circumferential direction and defining a first intermediate rib, a second intermediate rib and a central rib, the first intermediate rib and the second intermediate rib being placed on either side of the central rib; each of the shoulder portions shows a plurality of shoulder lateral grooves defining a plurality of shoulder blocks in the shoulder portion wherein at least one of the shoulder blocks shows at least one lateral sipe; each of the first intermediate rib and the second intermediate ribs shows a plurality of intermediate lateral grooves defining a plurality of intermediate blocks in the intermediate ribs, the intermediate lateral grooves of the first intermediate rib and the second intermediate rib extend in an inclined axial direction angularly opposite to each other; wherein the intermediate lateral grooves of at least one of the first intermediate rib and the second intermediate rib open on a main external groove and are arranged to face the central portion of a shoulder block according to the circumferential direction; and wherein the intermediate blocks of said intermediate ribs show a central sipe opened on main external groove and extending in an inclined axial direction angularly different from the shoulder lateral grooves adjacent to the shoulder portion; with preference, the central sipe of the intermediate blocks are arranged to have an opening on the main external groove facing another opening on the same main external groove of a shoulder lateral groove of the adjacent shoulder portion.

The following can be used to further define the tire according to the first aspect, the second aspect and the third aspect.

The tire of the disclosure is a pneumatic tire or a non-pneumatic tire; with preference, the tire is a pneumatic tire.

In an embodiment, at least one central sipe of the intermediate block and an adjacent shoulder lateral groove whose respective openings on the main external groove are facing have different angular inclinations to an axial direction.

In an embodiment, the central rib shows a plurality of lateral grooves defining a plurality of central blocks, wherein one or more lateral grooves are V-shaped.

For example, one or more of the central blocks show a central sipe that is V-shaped, said central sipe being opened on either side of the central block.

For example, one or more central blocks show one or more beveled corners.

In another embodiment, the central rib is a crown rib.

For example, the central rib shows one or more recesses with an axially inner end, each facing one of the intermediate lateral grooves of one of the first intermediate rib and the second intermediate rib; wherein the central rib further shows one or more sipes each extending from the axially inner end of one of the one or more recesses to another side of the central rib.

In an embodiment, said one or more sipes extend in an inclined axial direction angularly opposite to an inclined axial direction of the intermediate lateral groove faced by the one or more recesses.

In another embodiment, said one or more recesses extend in a same inclined axial direction angularly as the one of the intermediate lateral grooves faced by said one or more recesses.

For example, at least one sipe extending from the axially inner end of the one or more recesses to another side of the central rib is arranged to have an opening on the main central groove axially facing an opening on the same main central groove of a central sipe of an intermediate block.

For example, at least one sipe extending from the axially inner end of the one or more recesses to another side of the central rib is arranged to have an opening on the main central groove axially facing an opening on the same main external groove of a central sipe of an intermediate block; both sipes extending in a direction having a same angular inclination to the axial direction.

In an embodiment, at least one selected from the main external grooves, the main central grooves, or both the main external grooves and the main central grooves are straight or planar or circular.

In an embodiment, one or more of the intermediate blocks shows protrusions that fit with corresponding interlocking notches of the shoulder blocks so that the main central grooves separating the intermediate blocks from the shoulder blocks have a constant axial width over a circumferential direction.

In an embodiment, one or more of the intermediate blocks shows protrusions that fit with corresponding interlocking notches shown by the central rib so that the main intermediate grooves separating the intermediate blocks from the central rib have a constant axial width over a circumferential direction.

In an embodiment, at least a first circumferentially adjacent shoulder block and a second circumferentially adjacent shoulder block are spaced apart by a shoulder lateral groove having a groove bottom and at least one reinforcement element arranged within the shoulder lateral groove and extending between the first circumferentially adjacent shoulder block and the second circumferentially adjacent block.

In an embodiment, the central rib shows a plurality of lateral grooves defining a plurality of central blocks, wherein at least two lateral grooves being consecutive in a circumferential direction extend in an inclined axial direction angularly opposite to each other.

In an embodiment, the central rib is a crown rib that shows one or more sipes having one or more openings on the main central grooves facing at least one of an intermediate lateral groove and a central sipe of an intermediate block.

### Definitions

“Asymmetric tread” means a tread that has a tread pattern not symmetrical about the center plane or the equatorial plane of the tire.

“Symmetric tread” means a tread that has a tread pattern symmetrical about the center plane or the equatorial plane of the tire.

“Circumferential” means lines or direction extending along the perimeter of the surface of the annular tread perpendicular to the axial direction.

“Lateral groove” is a groove that has its longest dimension oriented at a direction non-parallel to the tire circumferential centerline. A lateral groove can be open into a void at both ends or be semi-blind in case it shows an extension at one of its ends. For example, the lateral grooves can extend according to the axial direction of the tire or according to a direction obliquely outward the tire tread width direction.

“Axial” means lines or directions that are parallel to the axis of rotation of the tire.

“Groove” means an elongated void area in a tread that can extend circumferentially or laterally about the tread in a straight, curved or zigzag manner. Circumferentially and laterally extending grooves sometimes have common portions.

The “groove width” is equal to tread surface area occupied by a groove or groove portion, the width of which is in question, divided by the length of the groove or groove portion in question. Thus, the groove width is its average width over its length.

The grooves may be of varying depth in a tire. The “depth” of a groove may vary along its length or be constant. The depth of one groove may be constant but varies from the depth of another groove in the tire. Narrow or wide lateral groove has a depth that is reduced compared to the main circumferential grooves which they interconnect.

“Sipes” means small slots molded into the tread elements that subdivide the tread surface and improve traction. A sipe is narrower than a groove.

“Tread element” or “traction element” means a rib or a block element defined by having a shape adjacent groove.

“Rib” means a circumferentially extending strip of rubber on the tread which is defined by at least one circumferential groove and either a second groove or a lateral edge. The strip is laterally divided by circumferential grooves.

“Lateral edge” means a line tangent to the laterally outermost or innermost tread contact footprint as measured under normal load and tire inflation, the line being parallel to the equatorial center plane.

“Equatorial center plane” means the plane perpendicular to the tire axis of rotation and passing through the center of the tread.

### BRIEF DESCRIPTION OF THE DRAWINGS

The invention will be described by way of example and with reference to the accompanying drawings in which:

FIG. 1 is an example of a tire tread pattern according to an embodiment of the disclosure; and

FIG. 2 is an example of a tire tread pattern according to another embodiment of the disclosure.

### DETAILED DESCRIPTION OF THE INVENTION

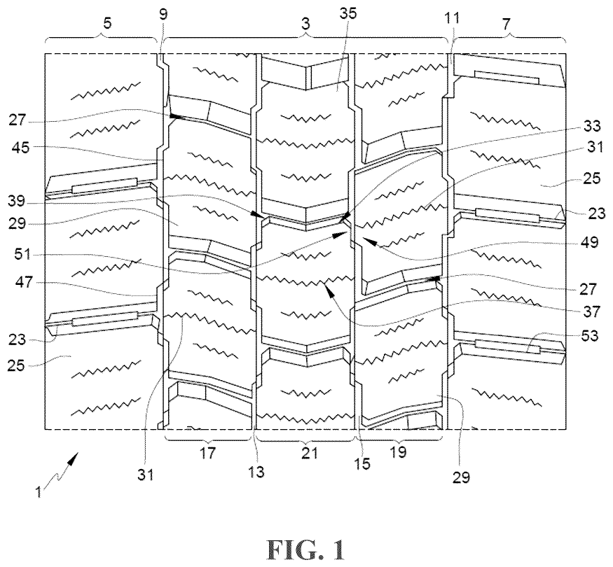

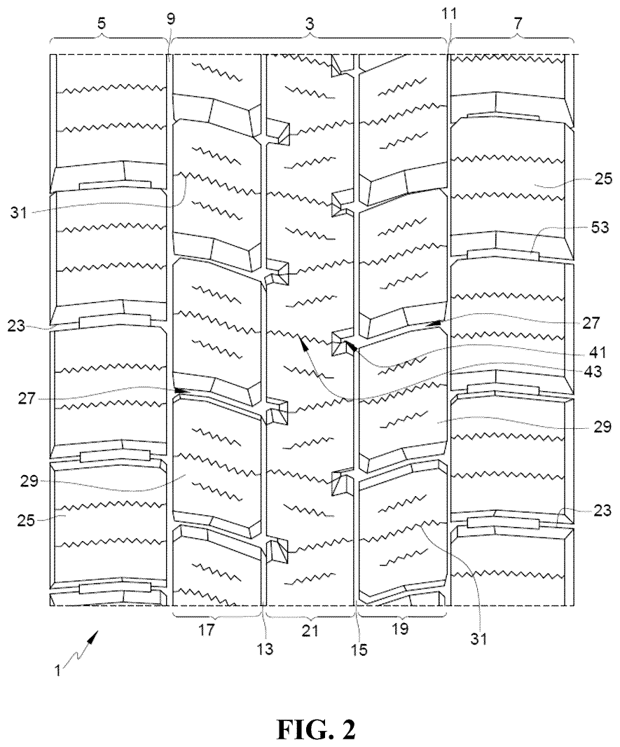

Reference is made to FIGS. 1 and 2 that are partial views of embodiments of the tread portion 1 of the tire according to the disclosure. Indeed, the tire includes a tread portion 1 extending in a tire width direction, a pair of sidewall portions (not shown) extending inward in a tire radial direction from both ends of the tread portion, and a pair of bead portions (not shown) each provided at an inner end of a corresponding one of the pair of sidewall portions in the tire radial direction. In the tread portion, a plurality of ribs is demarcated by a plurality of main circumferential grooves (i.e. extending in the tire circumferential direction). The tire can be a pneumatic tire or a non-pneumatic tire; with preference, the tire is a pneumatic tire.

As can be seen in FIGS. 1 and 2, the tire comprises a tread portion 1 that is divided in a tire width direction between a central portion 3 and at least one shoulder portion (5, 7); wherein the shoulder portion (5, 7) is placed adjacent to the central portion. A main external groove (9, 11) extends in a circumferential direction of the tire and is disposed between the central portion 3 and the shoulder portion (5, 7). The central portion 3 comprises at least one main central groove (13, 15) extending in the circumferential direction and defining at least one intermediate rib (17, 19) and a central rib 21, the intermediate rib (17, 19) being placed between the shoulder portion (5, 7) and the central rib 21. The shoulder portion (5, 7) shows a plurality of shoulder lateral grooves 23 defining a plurality of shoulder blocks 25. The intermediate rib (17, 19) shows a plurality of intermediate lateral grooves 27 defining a plurality of intermediate blocks 29.

When the tread portion comprises two shoulder portions (5, 7), the disclosure provides a tire comprising a tread portion 1 that is divided in a tire width direction between a central portion 3 and two shoulder portions (5, 7); the shoulder portions being placed on either side of the central portion 3. Two main external grooves (9, 11) extend in a circumferential direction of the tire and are disposed between the central portion 3 and two shoulder portions (5, 7). The central portion comprises two main central grooves (13, 15) extending in the circumferential direction and defining a first intermediate rib 17, a second intermediate rib 19, and a central rib 21. The first intermediate rib 17 and the second intermediate rib 19 are placed on either side of the central rib 21. Each of the shoulder portions (5, 7) has a plurality of shoulder lateral grooves 23 defining a plurality of shoulder blocks 25 in the shoulder portion. Each of the first intermediate rib 17 and second intermediate rib 19 has a plurality of intermediate lateral grooves 27 defining a plurality of intermediate blocks 29 in the intermediate ribs (17, 19).

In an embodiment illustrated in FIG. 1, at least one selected from the main external grooves (9, 11), the main central grooves (13, 15), or both the main external grooves and the main central grooves are straight. They extend along a geometrical planar surface perpendicular to the rotation. In another embodiment (not illustrated), at least one selected from the main external grooves, the main central grooves, or both the main external grooves and the main central grooves have a zig-zag shape.

In an embodiment illustrated in FIG. 2, one or more of the intermediate blocks 29 shows protrusions 45 that fit with corresponding interlocking notches 47 of the shoulder blocks 25 so that the main central grooves separating the intermediate blocks from the shoulder blocks have a constant width over their length.

For example, one or more of the intermediate blocks 29 shows protrusions 49 that fit with corresponding interlocking notches 51 shown by the central rib so that the main intermediate grooves separating the intermediate blocks from the central rib have a constant width over their length. This can be valid whether the central rib is divided into a plurality of central blocks or whether the central rib is a crown rib.

According to the disclosure, at least one shoulder block 25 shows at least one lateral sipe, with preference, each of the shoulder block 25 shows at least one lateral sipe. More preferably, one or more shoulder blocks 25 show two or more lateral sipes. The lateral sipes can be non-opening sipes (as illustrated in FIG. 1) or can be opening sipes that open at least the adjacent main groove (9, 11) (as illustrated in FIG. 2). Advantageously, the one or more sipes of the shoulder blocks 25 have a zig-zag shape.

The shoulder lateral grooves 23 have a first angle to the circumferential direction that ranges between 30° to 90°; preferably from 45° to 90°; more preferably from 60° to 90°. An angle of 90° means that the shoulder lateral grooves 23 extend according to the width of the tread portion. In a preferred embodiment, the tread portion shows a first shoulder portion 5 and a second shoulder portion 7, and the shoulder lateral grooves 23 of the first 5 and second 7 shoulder portions in an inclined axial direction angularly opposite to each other.

In a preferred embodiment, at least a first and a second circumferentially adjacent shoulder blocks 25 are spaced apart by a shoulder lateral groove 23 having a groove bottom and at least one reinforcement element 53 arranged within the shoulder lateral groove and extending between the first and the second circumferentially adjacent blocks 25. The reinforcement element extends the opposed sidewalls of the pair of shoulder blocks 25 and acts as a stiffener to reduce the bending and shearing the stresses on such shoulder blocks 25. The top surface of the reinforcing element 53 can be parallel to the tread surface or can be inclined to intersect a different surface of the two shoulder blocks 25. When the top surface of the reinforcing element 53 is inclined, the angle of inclination to the tread surface ranges from 30 to 60 degrees, preferably from 40 to 50 degrees. For example, the reinforcing element 53 has a length ranging from 30% to 80% of the width of the shoulder lateral groove 23 in the axial direction, preferably from 40% to 75%; more preferably from 50% to 70%. For example, the radial height of the reinforcement element is from 15% to 50% of the shoulder lateral groove 23 depth; for example from 25 to 40%.

The intermediate lateral grooves 27 show a second angle to the circumferential direction that ranges between 10° to 85°; preferably from 30° to 80°; more preferably from 50° to 78°. In a preferred embodiment, the intermediate lateral grooves 27 of the first intermediate rib 17 extend in an inclined axial direction angularly opposite to the direction of the intermediate lateral grooves 27 of the second intermediate rib 19.

In an embodiment, the intermediate lateral grooves 27 comprise two sections over their length of two different inclinations, wherein the first section opens on a main groove and the second section opens on a main central groove. The first section shows an angle to the circumferential direction and the second section shows another angle to the circumferential direction wherein the second angle to the circumferential direction is the direction of the hypotenuse of a triangle comprising the first and second section.

In a preferred embodiment, the second angle to the circumferential direction shown by the intermediate lateral grooves 27 is different from the first angle shown by the shoulder lateral grooves 23; preferably the second angle to the circumferential direction shown by the intermediate lateral grooves 27 is smaller than the first angle shown by the shoulder lateral grooves 23. For example, the first angle to the circumferential direction shown by the shoulder lateral grooves 23 is 90° and the second angle to the circumferential direction shown by the intermediate lateral grooves 27 is 80°. In another example, the first angle to the circumferential direction shown by the shoulder lateral grooves 23 is 80° and the second angle to the circumferential direction shown by the intermediate lateral grooves 27 is 60°.

In a preferred embodiment, the intermediate blocks 29 show a central sipe 31 extending in the same direction as the adjacent intermediate lateral grooves 27; said central sipe 31 is opened on either side of the intermediate block 29 and arranged to have an opening on the main external groove facing an opening on the same main external groove (9, 11) of an adjacent shoulder lateral groove 23. The intermediate blocks 29 preferably show one or more additional sipes; preferably the one or more additional sipes are non-opening sipes. Advantageously, the one or more sipes of the intermediate blocks 29 have a zig-zag shape.

In a preferred embodiment, the intermediate lateral grooves 27 of at least one of the first intermediate rib 17 and second intermediate rib 19 open on a main external groove (9, 11) and are arranged to face the central portion of a shoulder block 25 according to the circumferential direction; and wherein the intermediate blocks 29 of said intermediate ribs (17, 19) show a central sipe 31 opened on main external groove and extending in an inclined axial direction angularly different from the shoulder lateral grooves 23 of the adjacent shoulder portion (5, 7).

With preference, at least one central sipe 31 of the intermediate block and an adjacent shoulder lateral groove 23 whose respective openings on the main external groove are facing have different angular inclinations to the axial direction.

In an embodiment illustrated in FIG. 1, the central rib 21 shows a plurality of lateral grooves 33 separating a plurality of central blocks 35. The one or more lateral grooves can be straight with an inclination to the axial direction or can be V-shaped; with preference, the one or more lateral grooves are V-shaped. In a non-illustrated embodiment, the central rib shows a plurality of lateral grooves defining a plurality of central blocks, wherein at least two lateral grooves, which are consecutive in the circumferential direction, are straight and extend in directions inclined with respect to the axial direction, said directions being opposite to each other.

The central blocks 35 preferably exhibit one or more sipes. For example, they show a central sipe 37 that is oriented in the same direction as the lateral grooves 33. Thus, when the one or more lateral grooves 33 are V-shaped, the central sipes 37 of the central blocks 35 are V-shaped as well. The central sipes 37 can be non-opening sipes or be opened on either side of the central block; preferably said central sipes are opened on either side of the central block. The central blocks 35 preferably show one or more additional sipes; preferably the one or more additional sipes are non-opening sipes. Advantageously the one or more sipes of the central blocks 35 have a zig-zag shape. It is understood that the expression “non-opening sipes” means sipes which are not open on a circumferential groove. The central blocks 35 are axially broader.

In a preferred embodiment, one or more central blocks 35 show one or more beveled corners 39. This configuration allows for noise reduction of the tire. For example, at least two corners of each of the central blocks are beveled.

In an embodiment illustrated in FIG. 2, the central rib 21 is a crown rib. In such a case, noise reduction is achieved. The central rib 21 shows one or more recesses 41 with an axially inner end, each facing an intermediate lateral groove 27 of the first intermediate rib 17 or the second intermediate rib 19. The central rib further shows at least one sipe 43 extending from the axially inner end of such a recess 41 to another side of the central rib 21. The at least one sipe 43 extends from the axial bottom of the recess 41 to the axially opposite side of the central rib 21. The crown central rib 21 preferably shows one or more additional sipes; preferably the one or more additional sipes are non-opening sipes. Advantageously the one or more sipes of the crown central rib 21 have a zig-zag shape. For example, the non-opening additional sipes follow one another in the circumferential direction with alternated inclined directions.

In a preferred embodiment, the sipe 43 extending from the axially inner end of the recess 41 to another side of the central rib 21 (i.e. the crown central rib 21) extends in an inclined axial direction angularly opposite to the inclined axial direction of the intermediate lateral groove 27 faced by the recess 41.

For example, the recess 41 extends in the same inclined axial direction as the one of the intermediate lateral grooves 27 faced by said recess. In such a case the recess and the sipe 43 extending from the axially inner end of the recess 41 may extend in an inclined axial direction angularly opposite to each other.

Advantageously, at least one sipe 43 extending from the axially inner end of the recess 41 to another side of the central rib 21 is arranged to have an opening on the main central groove (13, 15) axially facing an opening on the same main central groove of a central sipe 31 of an intermediate block 29. In such a configuration, it can be advantageous that one or more sipes 43 extending from the axially inner end of the recess 41 to another side of the central rib 21 and the central sipe 31 of a neighbouring intermediate block 29 span in extension of each other. In such a case, at least one sipe 43 extending from the axially inner end of the recess 41 to another side of the central rib 21 is arranged to have an opening on the main central groove axially facing an opening on the same main external groove of a central sipe 31 of an intermediate block; both sipes extending in a direction having the same angular inclination to the axial direction.

For example, the sipes 43 extending from the axially inner end of the recess 41 to another side of the central rib 21 (i.e. the crown central rib 21) have an axial length greater than 50% of the width of the central rib in the axial direction. With preference, the axial length ranges from greater than 50% to 90% of the width of the central rib in the axial direction, preferably from 55% to 85%; more preferably from 60% to 80%.

In an embodiment, the central rib is a crown rib 21 that shows one or facing an intermediate lateral groove 27 or a central sipe 31 of an intermediate block.

Variations in the present invention are possible in light of the description of it provided herein. While certain representative embodiments and details have been shown for the purpose of illustrating the subject invention, it will be apparent to those skilled in this art that various changes and modifications can be made therein without departing from the scope of the subject invention. It is, therefore, to be understood that changes can be made in the particular embodiments described which will be within the full intended scope of the invention as defined by the following appended claims.

What is claimed is:

1. A tire comprising a tread portion that is divided in a tire width direction between a central portion and two shoulder portions; the shoulder portions being placed on either side of the central portion; wherein two main external grooves extending in a circumferential direction of the tire are each disposed between the central portion and one of the two shoulder portions; wherein the central portion comprises two main central grooves extending in the circumferential direction and defining a first intermediate rib, a second intermediate rib and a central rib, the first intermediate rib and the second intermediate ribs being placed on either side of the central rib; each of the shoulder portions has a plurality of shoulder lateral grooves defining a plurality of shoulder blocks in the shoulder portion; wherein at least one shoulder block shows at least one lateral sipe; each of the first intermediate rib and the second intermediate rib has a plurality of intermediate lateral grooves defining a plurality of intermediate blocks in the intermediate ribs, the intermediate lateral grooves of the first intermediate rib extend in an inclined axial direction angularly opposite to a direction of the intermediate lateral grooves of the second intermediate rib,
wherein the intermediate blocks show a central sipe extending in a same direction as the adjacent intermediate lateral grooves; said central sipe is opened on either side of the intermediate block and arranged to have an opening on the main external groove facing an opening on the same main external groove of an adjacent shoulder lateral groove.

2. The tire of claim 1 wherein at least one central sipe of the intermediate block and an adjacent shoulder lateral groove whose respective openings on the main external groove are facing have different angular inclinations to an axial direction.

3. The tire of claim 1 wherein the central rib shows a plurality of lateral grooves defining a plurality of central blocks, wherein one or more lateral grooves are V-shaped.

4. The tire of claim 3 wherein one or more of the central blocks show a central sipe that is V-shaped, said central sipe being opened on either side of the central block.

5. The tire of claim 3 wherein one or more central blocks show one or more bevelled corners.

6. The tire of claim 1 wherein the central rib is a crown rib.

7. The tire of claim 6 wherein the central rib shows one or more recesses with an axially inner end, each facing one of the intermediate lateral grooves of one of the first intermediate rib and the second intermediate rib; wherein the central rib further shows one or more sipes each extending from the axially inner end of one of the one or more recesses to another side of the central rib.

8. The tire of claim 7 wherein said one or more sipes extend in an inclined axial direction angularly opposite to an inclined axial direction of the intermediate lateral groove faced by the one or more recesses.

9. The tire of claim 7 wherein said one or more recesses extends in a same inclined axial direction angularly as the one of the intermediate lateral grooves faced by said recess.

10. The tire of claim 7 wherein at least one sipe extending from the axially inner end of the one or more recesses to another side of the central rib is arranged to have an opening on the main central groove axially facing an opening on the same main central groove of a central sipe of an intermediate block.

11. The tire of claim 7 wherein at least one sipe extending from the axially inner end of the one or more recesses to another side of the central rib is arranged to have an opening on the main central groove axially facing an opening on the same main external groove of a central sipe of an intermediate block; both sipes extending in a direction having a same angular inclination to the axial direction.

12. The tire of claim 1 wherein at least one selected from the main external grooves, the main central grooves, or both the main external grooves and the main central grooves are straight.

13. The tire of claim 1 wherein one or more of the intermediate blocks shows protrusions that fit with corresponding interlocking notches of the shoulder blocks so that the main central grooves separating the intermediate blocks from the shoulder blocks have a constant axial width over a circumferential direction.

14. The tire of claim 1 wherein one or more of the intermediate blocks shows protrusions that fit with corresponding interlocking notches shown by the central rib so that the main intermediate grooves separating the intermediate blocks from the central rib have a constant axial width over a circumferential direction.

15. The tire of claim 1 wherein at least a first circumferentially adjacent shoulder block and a second circumferentially adjacent shoulder block are spaced apart by a shoulder lateral groove having a groove bottom and at least one reinforcement element arranged within the shoulder lateral groove and extending between the first circumferentially adjacent shoulder block and the second circumferentially adjacent block.

16. A tire comprising a tread portion that is divided in a tire width direction between a central portion and at least one shoulder portion; the shoulder portion being placed adjacent to the central portion; wherein a main external groove extending in a circumferential direction of the tire is disposed between the central portion and the shoulder portion;
wherein the central portion comprises at least one main central groove extending in a circumferential direction and defining at least one intermediate rib and a central rib, the intermediate rib being placed between the shoulder portion and the central rib; the shoulder portion shows a plurality of shoulder lateral grooves defining a plurality of shoulder blocks wherein at least one shoulder block shows at least one lateral sipe; the intermediate rib shows a plurality of intermediate lateral grooves defining a plurality of intermediate blocks,
wherein the intermediate blocks show a central sipe extending in a same direction as the lateral grooves of the intermediate rib; said central sipe is opened on the main external groove and faces the opening on the main external groove of a shoulder lateral groove of the adjacent shoulder portion.

17. The tire of claim 16, wherein the central rib shows a plurality of lateral grooves defining a plurality of central blocks, wherein at least two lateral grooves being consecutive in a circumferential direction extend in an inclined axial direction angularly opposite to each other.

18. The tire of claim 16 wherein the central rib is a crown rib that shows one or more sipes having one or more openings on the main central grooves facing at least one of an intermediate lateral groove and a central sipe of an intermediate block.

19. A tire comprising a tread portion that is divided in a tire width direction between a central portion and two shoulder portions; the shoulder portions being placed on either side of the central portion; wherein two main external grooves extending in a circumferential direction of the tire are disposed between the central portion and two shoulder portions;
wherein the central portion comprises two main central grooves extending in a circumferential direction and defining a first intermediate rib, a second intermediate rib and a central rib, the first intermediate rib and the second intermediate rib being placed on either side of the central rib; each of the shoulder portions shows a plurality of shoulder lateral grooves defining a plurality of shoulder blocks in the shoulder portion wherein at least one of the shoulder blocks shows at least one lateral sipe; each of the first intermediate rib and the second intermediate ribs shows a plurality of intermediate lateral grooves defining a plurality of intermediate blocks in the intermediate ribs, the intermediate lateral grooves of the first intermediate rib and the second intermediate rib extend in an inclined axial direction angularly opposite to each other;
wherein the intermediate lateral grooves of at least one of the first intermediate rib and the second intermediate rib open on a main external groove and are arranged to face the central portion of a shoulder block according to the circumferential direction; and
wherein the intermediate blocks of said intermediate ribs show a central sipe opened on main external groove and extending in an inclined axial direction angularly different from the shoulder lateral grooves adjacent to the shoulder portion.

20. The tire of claim 19 wherein the central sipe of the intermediate blocks are arranged to have an opening on the main external groove facing another opening on the same main external groove of a shoulder lateral groove of the adjacent shoulder portion.
